(19) United States
(12) Patent Application Publication
(10) Pub. No.: US 2026/0310672 A1
(43) Pub. Date: Oct. 8, 2026

(54) OBTAINING RECOMMENDED DATA SOURCES FROM USER QUERY DATA

(71) Applicant: Dell Products L.P., Round Rock, TX (US)

(72) Inventors: ZIJIA WANG, London (GB); XIAOCHEN CHEN, Shanghai (CN); NING LI, Shanghai (CN); ASHUTOSH P. NANEKAR, Cary, NC (US)

(21) Appl. No.: 19/098,850

(22) Filed: Apr. 2, 2025

(51) Int. Cl. G06F 16/2457; G06F 16/2458

(52) U.S. Cl. CPC G06F 16/2457; G06F 16/2477

(57) ABSTRACT

Methods and systems for providing desired computer implemented services using data stored in data sources of a distributed system are disclosed. The desired computer implemented services may be provided by obtaining recommended data sources of the data sources using user query data. The user query data may be used to obtain temporal data access patterns by a user and/or relative levels of importance of the data sources indicated by the temporal data access patterns, both of which can be used to obtain recommended data sources. The recommended data sources may be used with a request template to generate an information request that is processable by information extraction frameworks. From processing the information request, information may be obtained that is used to facilitate the desired computer implemented services.

### FIELD

Embodiments disclosed herein relate generally to providing desired computer implemented services using data stored in data sources of a distributed system. More particularly, embodiments disclosed herein relate to obtaining recommended data sources using user query data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams illustrating operation of a system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to providing desired computer implemented services using data stored in data sources of a distributed system. The desired computer implemented services may be provided by obtaining recommended data sources of the data sources using user query data.

The recommended data sources may be generated by (i) generating a preliminary recommendation and/or (ii) performing a first adjustment of the preliminary recommendation. The preliminary recommendation may include a weighted sum of (i) a first recommendation based on filtering of the data sources, (ii) a second recommendation based on clustering of the data sources, and/or (iii) a third recommendation based on predictive modeling of the data sources.

The first adjustment may be modifying at least one weight of the weighted sum. The first adjustment may be performed using the user profile embeddings and/or context of user queries by the user. The user profile embeddings may be based on temporal data access patterns by the user and/or relative levels of importance of the data sources indicated by the temporal data access patterns. The context may include (a) a frequency of any portion of the user queries, (b) a diversity of the data sources and/or the user queries, etc.

The at least one weight may be modified by performing similarity computations between contextual contrast embeddings and/or recommendation embeddings generated from the recommendation method to generate the at least one weight. The contextual contrast embeddings may include a difference between the user profile embeddings and/or user query data embeddings. The user query data embeddings may include embeddings based on the user queries.

The recommended data sources may be used to identify data source identifiers of the data sources of the distributed system. Upon the identification, placeholders of a request template may be replaced with the data source identifiers to generate an information request for the data. The information request may be processable by information extraction frameworks.

Upon processing, by the information extraction frameworks, of the information request, the information may be obtained. The information may be used to facilitate a provisioning of the desired computer implemented services by the distributed system.

In an embodiment, a method for providing desired computer implemented services using data stored in data sources of a distributed system is disclosed. The method may include: (i) obtaining a data request from a user, the data request being serviceable using a portion of the data stored in the data sources, (ii) obtaining, based on the data request and using a request template corresponding to the data request and an updated user query data profile for the user, recommended data sources for the request template, the updated user query data profile being based on temporal data access patterns by a user and relative levels of importance of the data sources indicated by the temporal data access patterns, (iii) obtaining, using the request template and the recommended data sources, an information request that is compatible with information extraction frameworks for the data sources, (iv) obtaining, using the information request, the portion of the data, and (v) using the portion of the data to facilitate provisioning of at least the portion of the desired computer implemented services.

The data request may not be compatible with the information extraction frameworks for obtaining of the portion of the data.

Obtaining the recommended data sources may include (i) generating, as a preliminary recommendation, a weighted sum of, at least (a) a first recommendation based on filtering of the data sources, (b) a second recommendation based on clustering of the data sources, and (c) a third recommendation based on predictive modeling of the data sources, and (ii) adjusting, using on at least the updated user query data profile and historical query context of the user, at least one weight used to generate the weighted sum to obtain the recommended data sources.

The temporal data access patterns may include a sequence of at least one query embedding based on at least one query that was processed on at least one first time.

The information request may include a query usable to obtain the portion of the data.

The updated user query data profile may be updated over time as new queries are executed on behalf of the user.

The at least one query embedding may be based on at least one embedding of the data sources.

Obtaining the recommended data sources may further include performing, using a feedback embedding and the updated user query data profile, a further adjustment that modifies how the recommended data sources are obtained, the feedback embedding being based on user-driven feedback.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

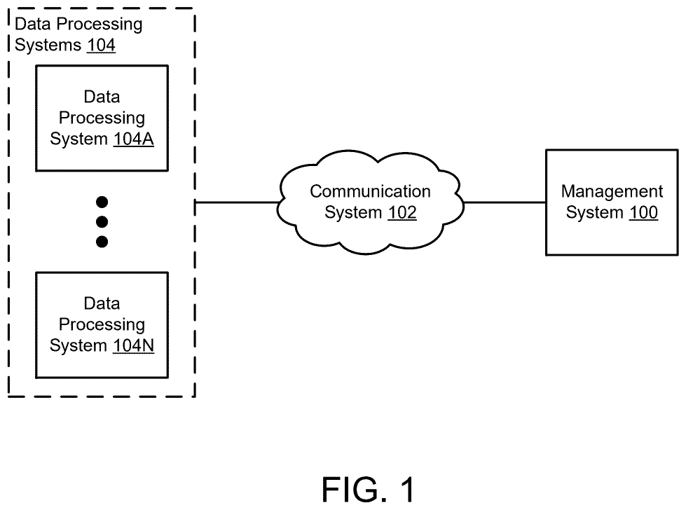

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a data request may be performed by an entity of the distributed system. The entity may include (i) a user, (ii) an administrator, and/or (iii) any other stakeholder of the distributed system. Information of the data request may include (i) performance data of the distributed system, (ii) traffic data of the distributed system, (iii) inventory data of items tracked by software of the distributed system, (iv) sales statistics in a database of the distributed system, etc. The data request may be performed by (i) transmitting the data request to the distributed system, (ii) retrieving, based on any parameter of the data request and/or by the distributed system, the information from software, databases, repositories, etc. of the distributed system, and/or (iii) transmitting, by the distributed system, the information to the entity.

However, the information, which has been retrieved by the distributed system, may not include (i) data, (ii) metadata, (iii) statistics, (iv) annotations, etc. that is relevant to at least one requirement and/or activity of the entity on the distributed system. As a result, provisioning, using the information and/or by the entity, of computer implemented services may be impacted.

In general, embodiments disclosed here relate to systems and methods for providing desired computer implemented services using data stored in data sources of a distributed system. The desired computer implemented services may be provided by (i) obtaining a data request, the data request being serviceable using a portion of the data stored in the data sources, (ii) obtaining, based on the data request and/or using a request template corresponding to the data request and an updated user query data, recommended data sources for the request template, the updated user query data being based on temporal data access patterns by a user and relative levels of importance of the data sources indicated by the temporal data access patterns, (iii) obtaining, using the request template and/or the recommended data sources, an information request that is compatible with information extraction frameworks for the data sources, (iv) obtaining, using the information request, the portion of the data, and/or (v) using the portion of the data to facilitate provisioning of at least the portion of the desired computer implemented services.

The data request may be obtained by receiving, by the distributed system and/or from the entity, the data request for information from an entity. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc.

The recommended data sources may be obtained by (i) generating a preliminary recommendation and/or (ii) performing a first adjustment of the preliminary recommendation to obtain the recommended data sources. The preliminary recommendation may include a weighted sum of (i) a first recommendation based on filtering of the data sources, (ii) a second recommendation based on clustering of the data sources, and/or (iii) a third recommendation based on predictive modeling of the data sources.

A recommendation method (e.g., (i) the filtering, (ii) the clustering, and/or (iii) the predictive modeling) may be performed using at least one machine learning model (e.g., (i) collaborative filtering models, (ii) K-means clustering models, (iii) hierarchical clustering models, (iv) recurrent neural networks, and/or (v) any other machine learning model) and/or a user query data profile. The user query data profile may include a user profile embeddings based on at least attention weights and/or hidden states for the embeddings of user queries. The attention weights may assign a level of importance between the at least two embeddings. The hidden states may include temporal access patterns of the user queries. The embeddings may include a n-dimensional vector and/or any other numerical representation of the user queries.

The first adjustment may be performed by modifying at least one weight of the weighted sum. The first adjustment may be performed using the user profile embeddings and/or context of the user queries. The context may include (a) a frequency of any portion of the user queries, (b) a diversity of the data sources and/or the user queries, etc. The at least one weight may be modified by performing similarity computations between contextual contrast embeddings and/or recommendation embeddings generated from the recommendation method to generate the at least one weight. The contextual contrast embeddings may include a difference between the user profile embeddings and/or user query data embeddings. The user query data embeddings may include the embeddings based on the user queries.

A second adjustment may further be performed to qualify the recommended data sources and/or update the at least one machine learning model that used the recommendation method. The recommended data sources may be qualified by (i) assessing a data quality (e.g., at least one check for (a) missing values, (b) outliers, and/or (c) inconsistencies of the at least one weight), (ii) performing new relevance scoring on the recommended data sources, (iii) generating new relevance scores for the recommended data sources, etc. The at least one machine learning model may be updated using user-driven feedback to perform the second adjustment on the recommendation method to improve future recommendations, etc.

The information request may be obtained (i) identifying data source identifiers of the recommended data sources and/or (ii) generating the information request using the data source identifiers. The information request may be generating by replacing the placeholders of the request template with the data source identifiers.

The portion of the data may be obtained, using the information request, by transmitting the information request to the information extraction frameworks to (i) filter, (ii) prioritize, and/or (iii) retrieve the information. The information may include relevant data for use in the provisioning of the desired computer implemented services.

The portion of the data may be used to facilitate provisioning at least the portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

To provide the above noted functionality, the system may include management system 100, and/or data processing systems 104. Each of these components is discussed below.

Data processing systems 104 may include any number of data processing systems (e.g., 104A-104N). The any number of data processing systems may host an entity. The entity may include (i) a user, (ii) an administrator, and/or (iii) any other stakeholder of the distributed system. The entity may generate a data request for information. The data request may be received by the any number of data processing systems (e.g., 104A-104N).

The any number of data processing systems (e.g., 104A-104N) and/or management system 100 may store request templates, user query data profiles, and/or at least one machine learning model in any number of databases, repositories, and/or any other storage systems. The at least one machine learning model may include (i) collaborative filtering models, (ii) K-means clustering models, (iii) hierarchical clustering models, (iv) recurrent neural networks, and/or (v) any other machine learning model.

The any number of data processing systems (e.g., 104A-104N) and/or management system 100 may also utilize information extraction frameworks to utilize the request templates and/or the user query data profiles to generate an information request. Examples of the information extraction frameworks may include (i) Structured Query Language (SQL), (ii) NoSQL, (iii) ORM (Object Related Mapping) Frameworks, (iv) Apache Hive, (v) ELK (Elasticsearch, Logstash, Kibana) Search, etc.

The information request may be processed by the any number of data processing systems (e.g., 104A-104N). By processing the information request, the any number of data processing systems (e.g., 104A-104N) may facilitate provisioning of desired computer implemented services.

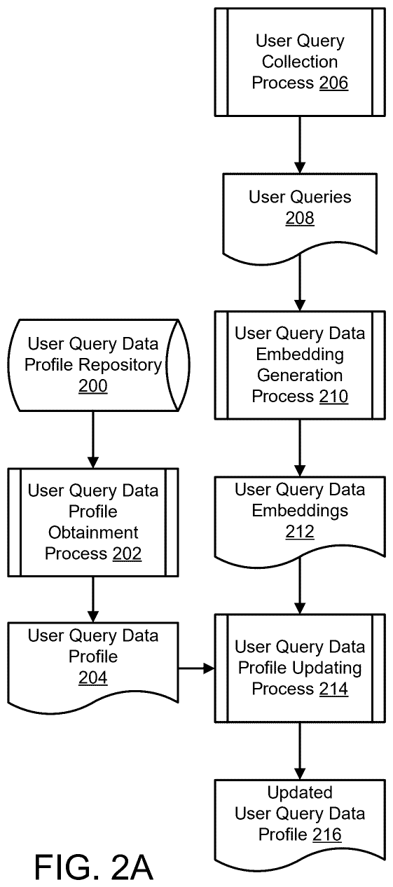

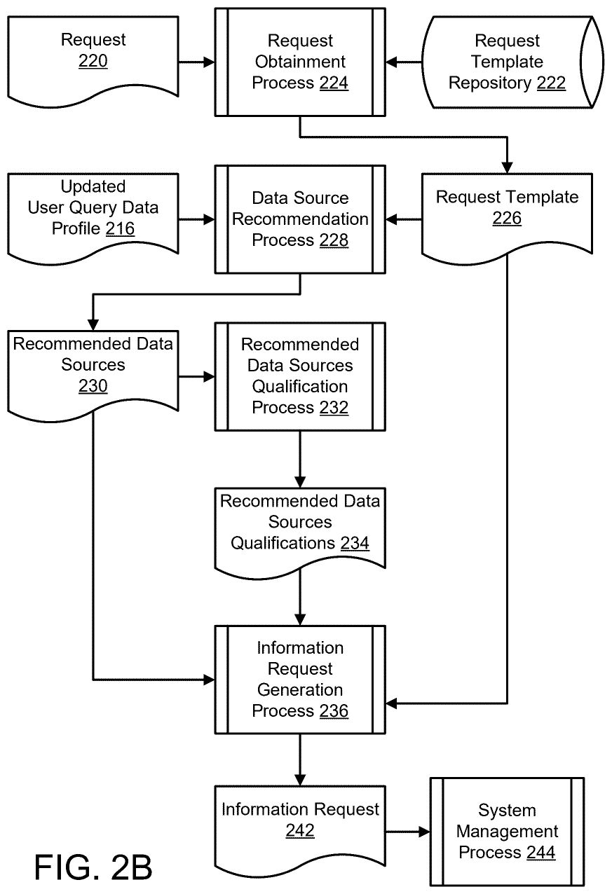

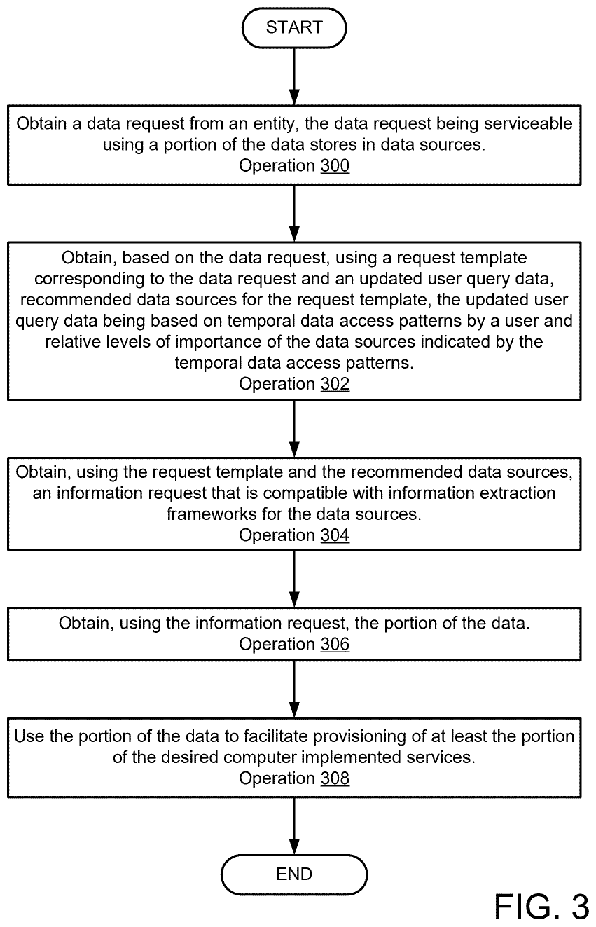

While providing their functionality, any of management system 100 and data processing systems 104 may perform all, or a portion, of the flows and methods shown in FIGS. 2A-3.

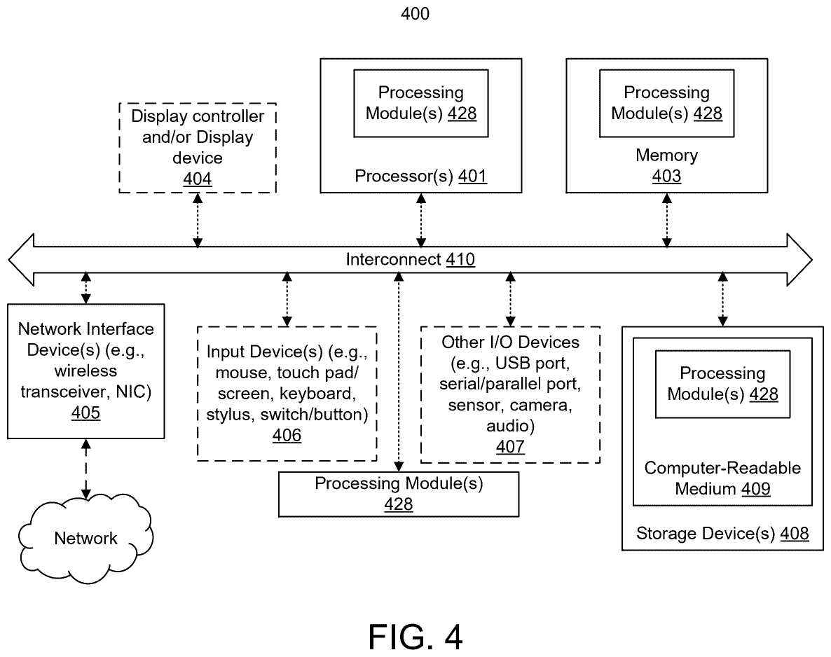

Any of (and/or components thereof) management system 100 and data processing system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 204, 208, etc.) is used to represent data structures, a second set of shapes (e.g., 202, 206, etc.) is used to represent processes performed using and/or that generate data, and a third set of shapes (e.g., 200, 222, etc.) is used to represent large scale data structures such as databases.

Turning to FIG. 2A, a first data flow diagram in accordance with an embodiment is shown. The first data flow diagram may illustrate data used in and data processing performed in generating an updated user query data profile.

To generate the updated user query data profile (e.g., 216), a user query collection process (e.g., 206) may be performed. During the user query collection process (e.g., 206), user queries (e.g., 208) may be obtained. The user queries (e.g., 208) may be obtained by (i) identifying a user who generated and/or initiated processing of the user queries (e.g., 208) and/or (ii) identifying the user queries (e.g., 208) in a first repository of queries. The user may be identified by performing a first search for an identification of the user from the user queries (e.g., 208). The user queries (e.g., 208) may be identified by performing a first search in the first repository based on the identification of the user. The first search may also be based on a period. The period may include a time between a first historical timestamp (e.g., a first data and/or first time) and/or a present timestamp (e.g., a current date and/or current time).

Results of the first search may include the user queries (e.g., 208). The user queries (e.g., 208) may include at least one processable query by the user. The user queries (e.g., 208) may be processable by an information extraction framework for retrieval of first information from the distributed system.

The user queries (e.g., 208) may include statements and/or clauses. The statements and/or clauses may include types of words used for finding the first information in data sources. The data sources may include (i) data tables, (ii) application programming interfaces (APIs), (iii) data warehouses, (iv) cloud storage, etc. The types of words may include (i) table names, (ii) field names, (iii) operation words (e.g., (a) “select,” (b) “insert,” (c) “insert,” (d) “delete,” and/or € any other operation words), (iv) relationship words (e.g., (a) “join,” (b) “inner join,” (c) “left join,” (d) “right join,” and/or € any other relationship words), (v) symbols, etc.

Once the user queries (e.g., 208) have been obtained, a user query data embedding generation process (e.g., 210) may be performed. During the user query data embedding generation process (e.g., 210), user query data embeddings (e.g., 212) of the user queries (e.g., 208) may be generated. The user query data embeddings (e.g., 212) may be generated first by ingesting the user queries (e.g., 208) in a word embedding model (e.g., (i) Word2Vec, (ii) GloVe (Global Vectors), (iii) BERT (Bidirectional Encoder Representation Transformers), and/or (iv) any other transformer model) to transform the user queries (e.g., 208) into the user query data embeddings (e.g., 212).

Once the user query data embeddings (e.g., 212) have been obtained, a user query data profile updating process (e.g., 214) may be performed. To perform the user query data profile updating process (e.g., 214), a user query data profile obtainment process (e.g., 202) may first be performed to obtain a user query data profile (e.g., 204) of the user.

During the user query data profile obtainment process (e.g., 202), a second search may be performed using at least the identification of the user. The second search may be performed in a user query data profile repository (e.g., 200). During the second search, the identification of the user may be used to identify the user query data profile (e.g., 204) of the user.

The user query data profile (e.g., 204) may include (i) the identification of the user, (ii) previous user profile embeddings for a previous set of the user queries (e.g., not 208) that was (a) initiated by the user for processing by the information extraction framework and/or (b) have been completed by the information extraction framework between a second historical timestamp (e.g., a second date that is earlier and/or later than the first date and/or second time that is earlier and/or later than the first time) and/or the first historical timestamp and/or the present timestamp, (iii) first references to at least one request template that are stored in a request template repository and/or have been used by the user, etc.

Using the user query data embeddings (e.g., 212), a temporal context of access patterns of the user maybe obtained by ingesting, by a first trained machine learning model, at least the user query data embeddings (e.g., 212) to generate hidden states of the user query data embeddings (e.g., 212). The first trained machine learning model may include (i) a recurrent neural network (RNN), (ii) a gated recurrent unit, (iii) a hidden Markov model, etc. The hidden states may include the temporal context of the access patterns of the user.

Next, the user query data embeddings (e.g., 212) may be used to obtain levels of importance between the user query data embeddings (e.g., 212). The levels of importance may be obtained by ingesting, by a second machine learning model, at least the user query data embeddings (e.g., 212) to generate attention weights of the user query data embeddings (e.g., 212). The second machine learning model may include (i) an attention-based RNN, (ii) a memory network, (iii) a graph neural network, etc. The attention weights may include measures of the levels of importance between the user query data embeddings (e.g., 212).

Finally, the hidden states and/or the attention weights may be aggregated hierarchically between at least the temporal context and/or the levels of importance to generate user profile embeddings. The user profile embeddings may be included by including the user profile embeddings with the previous user profile embeddings to (i) a category, (ii) a section, and/or (iii) any other portion of the user query data profile (e.g., 240).

By including the user profile embeddings with the previous user profile embeddings in the user query data profile (e.g., 240), an updated user query data profile (e.g., 216) may be generated. The updated user query data profile (e.g., 216) may include the second information, similar to the user query data profile (e.g., 204). The updated user query data profile (e.g., 216) may further include at least the user query data embeddings (e.g., 212) which are not included in the user query data profile (e.g., 204).

Thus, via the first data flow diagram illustrated in FIG. 2A, a system in accordance with an embodiment may generate the updated user query data profile (e.g., 216). Consequently, a distributed system may be more likely to be able to provide desired computer implemented services by using the user query data embeddings (e.g., 212) to generate user profile embeddings for the updated user query data profile (e.g., 216).

Turning to FIG. 2B, a second data flow diagram in accordance with an embodiment is shown. The second data flow diagram may illustrate data used in and data processing performed in servicing an information request to facilitate provision of desired computer implemented services.

To service the information request (e.g., 242), a request obtainment process (e.g., 224) may be performed. During the request obtainment process (e.g., 224), a user input may be obtained and/or ingested to generate a request (e.g., 220). The user input may include a generic request and/or an unstructured request for services and/or data. The user input may include, for example, a statement such as “retrieve any personal identifiable information of employees hired in the last year”, “provide the locations of the delivery vans,” “can you provide energy consumption information on all data processing systems?”

During the request obtainment process (e.g., 224), the user input may be ingested, for example, by a trained generative machine learning model (e.g., a large language model, a small language model, and/or any other natural language processing models, etc.) to generate the request template (e.g., 226). The trained generative machine learning model may be adapted to generate a structured request, including the request (e.g., 220), for the services.

As an alternative to using the trained generative machine learning model, a third search may be performed in a request template repository (e.g., 222) for the request template (e.g., 226). The third search may be performed by (i) the trained generative machine learning model, (ii) a user, (iii) an administrator, and/or (iv) any other entity of the distributed system. The third search may be performed by using any portion of the request (e.g., 220) as an input for the third search to find at least one request template in the request template repository (e.g., 222).

The request template (e.g., 226) may be similar to a user query of the user queries (e.g., 208 from FIG. 2A). However, the request template may include placeholders for data source identifiers of data sources. The data source identifiers may include any reference to the data of the data sources and/or any portion of the data of the data sources.

Once the request template (e.g., 226) has been obtained, a data source recommendation process (e.g., 228) may be performed. To perform the data source recommendation process (e.g., 228), an updated user query data profile (e.g., 216) may be ingested. The updated user query data profile (e.g., 216) was described in the description of FIG. 2A.

During the data source recommendation process (e.g., 228), recommended data sources (e.g., 230) may be obtained. The recommended data sources (e.g., 230) may be obtained by (i) generating a preliminary recommendation and/or (ii) performing a first adjustment of the preliminary recommendation to obtain the recommended data sources. The preliminary recommendation may include a weighted sum of (i) a first recommendation based on filtering of the data sources, (ii) a second recommendation based on clustering of the data sources, and/or (iii) a third recommendation based on predictive modeling of the data sources.

A recommendation method (e.g., (i) the filtering, (ii) the clustering, and/or (iii) the predictive modeling) may be performed using at least a third machine learning model (e.g., (a) collaborative filtering models, (b) K-means clustering models, (c) hierarchical clustering models, (d) RNNs, and/or € any other machine learning model) and/or user profile embeddings of the updated user query data profile (e.g., 216).

The first adjustment may be performed by modifying at least one weight of the weighted sum. The first adjustment may be performed using the user profile embeddings and/or context of the user queries. The context may include (a) a frequency of any portion of the user queries, (b) a diversity of the data sources and/or the user queries, etc. The at least one weight may be modified by performing similarity computations between contextual contrast embeddings and/or recommendation embeddings generated using the user profile embeddings to generate the at least one weight. The contextual contrast embeddings may include a difference between the user profile embeddings and/or user query data embeddings (e.g., 212).

The recommended data sources (e.g., 230) may include at least one recommended data source for the request (e.g., 220). The least one recommended data source may be included, for example, in a data file that includes (i) at least one first embedding (e.g., a first n-dimensional vector and/or any other first numerical representation), (ii) unstructured raw text, (iii) the raw text in a hierarchical format, and/or (iv) any other representation in any other format. The recommended data sources (e.g., 230) may further include data source identifiers of the recommended data sources specifically for input into the request template (e.g., 226) selected for the request (e.g., 226).

Using the recommended data sources (e.g., 230), a recommended data sources qualification process (e.g., 232) may be performed. During the recommended data sources qualification process (e.g., 232), at least one technique may be used to assess a relevance and/or quality of the recommended data sources (e.g., 230). The techniques may include (i) assessing a data quality (e.g., at least one check for (a) missing values, (b) outliers, and/or (c) inconsistencies of the at least one weight), (ii) performing new relevance scoring on the recommended data sources (e.g., 230), (iii) generating new relevance scores for the recommended data sources (e.g., 230), (iv) using user-driven feedback to perform a second adjustment on the recommendation method after the first adjustment to improve future recommendations, etc.

Recommended data sources qualifications (e.g., 234), generated from the recommended data sources qualifications process (e.g., 232), may include (i) at least one measure of quality of the at least one weight, (ii) relevancy scores of the recommended data sources (e.g., 230), (iii) at least one second adjustment of the at least third machine learning model that uses the recommendation method, etc.

Finally, using (i) the recommended data sources qualifications (e.g., 234), (ii) the recommended data sources (e.g., 230), and/or (iii) the request template (e.g., 226), an information request generation process (e.g., 236) may be performed. During the information request generation process (e.g., 236), the information request (e.g., 242) may be generated.

To generate the information request (e.g., 238), (i) placeholders of the request template (e.g., 226) may be identified, (ii) data source identifiers for the placeholders may be obtained from the recommended data sources (e.g., 230), and/or (iv) the placeholders may be replaced by the data source identifiers to generate the information request (e.g., 238).

The data source identifiers may be obtained by extracting any portion of data of the data source (e.g., (a) a column name, (b) a field name, (c) a data type, and/or (d) any other portion of the data) of the recommended data sources (e.g., 230). Further, before obtaining the any portion of the data, the recommended data sources qualifications (e.g., 234) may be used to determine whether to extract the any portion of the data from the data source. The determination may be based on, for example, (i) whether a first threshold of quality for the data source has been met and/or exceeded by the data source, (ii) whether a second threshold relevancy score has been met and/or exceeded by the data source, etc.

The information request (e.g., 242) may include the request template (e.g., 226) with the placeholders that have been replaced with the data source identifiers. As a result, the information request (e.g., 242) may include a processable query that can be ingested and/or processed by an information extraction framework to retrieve information from the distributed system.

Using the information request (e.g., 242), a system management process (e.g., 244) may be performed. During the system management process (e.g., 244), the information may be retrieved using the information request (e.g., 242) by transmitting the information request (e.g., 242) to the information extraction frameworks to (i) filter, (ii) prioritize, and/or (iii) retrieve the information. The information may include relevant data for use in the provisioning of the desired computer implemented services.

The information may be used to facilitate provisioning at least a portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

Thus, via the second data flow diagram illustrated in FIG. 2B, a system in accordance with an embodiment may service the information request (e.g., 238). Consequently, a distributed system may be more likely to be able to provide desired computer implemented services by generating, using at least the recommended data sources (e.g., 230), an information request (e.g., 242) for retrieval of the information used to facilitate a provisioning of desired computer implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices.

For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide desired computer implemented services using data stored in data sources of a distributed system. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing the desired computer implemented services using the data stored in the data sources of the distributed system in accordance with an embodiment is shown. The method may be performed, for example, by any of the components of the system of FIG. 1, and/or other components not shown therein.

At operation 300, a data request may be obtained from a user, the data request being serviceable using a portion of the data stored in the data sources. The data request may be obtained by receiving, by the distributed system and/or from the entity, the data request for information. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc.

At operation 302, recommended data sources for a request template may be obtained using the request template corresponding to the data request and an updated user query data profile for the user, the updated user query data profile being based on temporal data access patterns by a user and relative levels of importance of the data sources indicated by the temporal data access patterns. The recommended data sources may be obtained by (i) generating, as a preliminary recommendation, a weighted sum of, at least (a) a first recommendation based on filtering of the data sources, (b) a second recommendation based on clustering of the data sources, and (c) a third recommendation based on predictive modeling of the data sources; and (ii) adjusting, using on at least the updated user query data profile and historical query context of the user, at least one weight used to generate the weighted sum to obtain the recommended data sources.

The preliminary recommendation may be generated by performing (i) the filtering, (ii) the clustering, and/or (iii) the predictive modeling using the data sources and/or assigning a similar value for each weight of the at least one weight to demonstrate an equal contribution by (i) the filtering, (ii) the clustering, and/or (iii) the predictive modeling to the preliminary contribution. The at least one weight may be adjusted by performing a similarity computation using (i) contextual contrast embeddings and/or (ii) user profile embeddings. The contextual contrast embeddings may include a difference between the user profile embeddings and/or user query data embeddings. The user profile embeddings may include a hierarchical aggregation based on at least attention weights and/or hidden states for the user query data embeddings. The user query data embeddings may include embeddings based on the user queries.

The recommended data sources may be further obtained by performing, using a feedback embedding and the updated user query data profile, a second adjustment that modifies how the first adjustment is performed, the feedback embedding being based on user-driven feedback. The second adjustment may be performed by (i) ingesting, by at least one machine learning model that uses a recommendation method to generate the at least one weight, the feedback embedding that is based on the user-driven feedback and/or (ii) further training the at least one machine learning model so that a future at least one weight is generated based on the user-driven feedback.

At operation 304, an information request may be obtained, using the request template and the recommended data sources, that is compatible with information extraction frameworks for the data sources. The information request may be obtained by (i) identifying, using the recommended data sources, data source identifiers related to the data request, and/or (ii) generating, using the data source identifiers and the request template, the information request by replacing at least one placeholder of the placeholders with at least one data source identifier of the data source identifiers.

At operation 306, the portion of the data may be obtained using the information request. The portion of the data may be obtained by transmitting the information request to the information extraction frameworks to (i) filter, (ii) prioritize, and/or (iii) retrieve the information. The information may include relevant data for use in the provisioning of the desired computer implemented services.

At operation 308, the portion of the data may be used to facilitate provisioning of at least the portion of the desired computer implemented services. The portion of the data may be used by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

The method may end following operation 308.

Thus, via the method shown in FIG. 3, embodiments herein may likely improve a likelihood of providing the desired computer implemented services using the data stored in the data sources of the distributed system. By improving the likelihood of providing the desired computer implemented services using the data stored in the data sources of the distributed system, the distributed system may be more likely to provide desirable computer implemented services by, for example, obtaining recommended data sources using at least the updated user query data profile for the user, using the recommended data sources for identification of data source identifiers for a retrieval of information, etc.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for providing desired computer implemented services using data stored in data sources of a distributed system, the method comprising:
obtaining a data request from a user, the data request being serviceable using a portion of the data stored in the data sources;
based on the data request:
obtaining, using a request template corresponding to the data request and an updated user query data profile for the user, recommended data sources for the request template, wherein
the updated user query data profile being based on temporal data access patterns by a user and relative levels of importance of the data sources indicated by the temporal data access patterns, and
for each recommended data source, recommended data source qualifications are generated including a quality score and a relevance score for the corresponding recommended data source;
obtaining, using the request template, the recommended data source qualifications, and the recommended data sources, an information request that is compatible with information extraction frameworks for the data sources, where a given recommended data source is accessed only when the corresponding quality score satisfies a quality threshold and corresponding relevance score satisfy a relevance threshold;
obtaining, using the information request, the portion of the data; and
using the portion of the data to facilitate provisioning of at least the portion of the desired computer implemented services.

2. The method of claim 1, wherein the data request is not compatible with the information extraction frameworks for obtaining of the portion of the data.

3. The method of claim 1, wherein obtaining the recommended data sources comprises:
generating, as a preliminary recommendation, a weighted sum of, at least:
a first recommendation based on filtering of the data sources,
a second recommendation based on clustering of the data sources, and
a third recommendation based on predictive modeling of the data sources; and
adjusting, using on at least the updated user query data profile and historical query context of the user, at least one weight used to generate the weighted sum to obtain the recommended data sources.

4. The method of claim 1, wherein the temporal data access patterns comprise a sequence of at least one query embedding based on at least one query that was processed on at least one first time.

5. The method of claim 1, wherein the information request is a query usable to obtain the portion of the data.

6. The method of claim 1, wherein the updated user query data profile is updated over time as new queries are executed on behalf of the user.

7. The method of claim 4, wherein the at least one query embedding is based on at least one embedding of the data sources.

8. The method of claim 4, wherein obtaining the recommended data sources further comprises performing, using a feedback embedding and the updated user query data profile, a further adjustment that modifies how the recommended data sources are obtained, the feedback embedding being based on user-driven feedback.

9. A non-transitory machine-readable medium having instructions stored therein, which when executed by a processor, cause the processor to perform operations for providing desired computer implemented services using data stored in data sources of a distributed system, the operations comprising:
obtaining a data request from a user, the data request being serviceable using a portion of the data stored in the data sources;
based on the data request:
obtaining, using a request template corresponding to the data request and an updated user query data profile for the user, recommended data sources for the request template, wherein
the updated user query data profile being based on temporal data access patterns by a user and relative levels of importance of the data sources indicated by the temporal data access patterns, and
for each recommended data source, recommended data source qualifications are generated including a quality score and a relevance score for the corresponding recommended data source;
obtaining, using the request template, the recommended data source qualifications, and the recommended data sources, an information request that is compatible with information extraction frameworks for the data sources, where a given recommended data source is accessed only when the corresponding quality score satisfies a quality threshold and corresponding relevance score satisfy a relevance threshold;
obtaining, using the information request, the portion of the data; and
using the portion of the data to facilitate provisioning of at least the portion of the desired computer implemented services.

10. The non-transitory machine-readable medium of claim 9, wherein the data request is not compatible with the information extraction frameworks for obtaining of the portion of the data.

11. The non-transitory machine-readable medium of claim 9, wherein obtaining the recommended data sources comprises:
generating, as a preliminary recommendation, a weighted sum of, at least:
a first recommendation based on filtering of the data sources,
a second recommendation based on clustering of the data sources, and
a third recommendation based on predictive modeling of the data sources; and
adjusting, using on at least the updated user query data profile and historical query context of the user, at least one weight used to generate the weighted sum to obtain the recommended data sources.

12. The non-transitory machine-readable medium of claim 9, wherein the temporal data access patterns comprise a sequence of at least one query embedding based on at least one query that was processed on at least one first time.

13. The non-transitory machine-readable medium of claim 9, wherein the information request is a query usable to obtain the portion of the data.

14. The non-transitory machine-readable medium of claim 9, wherein the updated user query data profile is updated over time as new queries are executed on behalf of the user.

15. A data processing system, comprising:
a processor; and
a memory coupled to the processor to store instructions, which when executed by the processor, cause the processor to perform operations providing desired computer implemented services using data stored in data sources of a distributed system, the operations comprising:
obtaining a data request from a user, the data request being serviceable using a portion of the data stored in the data sources;
based on the data request:
obtaining, using a request template corresponding to the data request and an updated user query data profile for the user, recommended data sources for the request template, wherein
the updated user query data profile being based on temporal data access patterns by a user and relative levels of importance of the data sources indicated by the temporal data access patterns, and
for each recommended data source, recommended data source qualifications are generated including a quality score and a relevance score for the corresponding recommended data source;
obtaining, using the request template, the recommended data source qualifications, and the recommended data sources, an information request that is compatible with information extraction frameworks for the data sources, where a given recommended data source is accessed only when the corresponding quality score satisfies a quality threshold and corresponding relevance score satisfy a relevance threshold;
obtaining, using the information request, the portion of the data; and
using the portion of the data to facilitate provisioning of at least the portion of the desired computer implemented services.

16. The data processing system of claim 15, wherein the data request is not compatible with the information extraction frameworks for obtaining of the portion of the data.

17. The data processing system of claim 15, wherein obtaining the recommended data sources comprises:
generating, as a preliminary recommendation, a weighted sum of, at least:
a first recommendation based on filtering of the data sources,
a second recommendation based on clustering of the data sources, and
a third recommendation based on predictive modeling of the data sources; and
adjusting, using on at least the updated user query data profile and historical query context of the user, at least one weight used to generate the weighted sum to obtain the recommended data sources.

18. The data processing system of claim 15, wherein the temporal data access patterns comprise a sequence of at least one query embedding based on at least one query that was processed on at least one first time.

19. The data processing system of claim 15, wherein the information request is a query usable to obtain the portion of the data.

20. The data processing system of claim 15, wherein the updated user query data profile is updated over time as new queries are executed on behalf of the user.
